(19) United States
(12) Patent Application Publication
(10) Pub. No.: US 2007/0011928 A1
(43) Pub. Date: Jan. 18, 2007

(54) Triangular warning sign for vehicles

(76) Inventor: Tsang-Hsuan Wang, Yang-Mei Town (TW)

Correspondence Address: LOWE HAUPTMAN BERNER, LLP, 1700 DIAGONAL ROAD, SUITE 300, ALEXANDRIA, VA, 22314, US

(21) Appl. No.: 11/182,767

(22) Filed: Jul. 18, 2005

(51) Int. Cl. G09F 7/00

(52) U.S. Cl. 40/612

(57) ABSTRACT

A triangular warning sign for vehicles includes a triangular carrier board, a power supply and a mount. The triangular board is used for carrying a triangular warning sign and the power supply while the mount makes the triangular board stand perpendicular to the ground. The triangular warning sign is composed by electro luminescent pieces or a plurality of light-emitting diodes. The power supply can be solar power supply, batteries, or a car charger and it can automatically switch between the solar energy and batteries depending on occasions for providing the triangular warning sign power. In usage, the invention illuminates by Electro Luminescent or light-emitting diode to achieve features of electricity-saving, safety, and enough brightness for better warning effect, more convenience and energy-saving. The present invention can further disposed with an alarm and the power supply is with both AC and DC charging capabilities.

### BACKGROUND OF THE INVENTION

The present invention relates to a triangular warning signs for vehicles, especially to a triangular warning sign composed by electro luminescent pieces or light-emitting diode and a multifunctional power supply for providing the triangular warning sign power to produce enough brightness so as to have warning effect.

When car accidents or breakdowns happened, a triangular warning sign is set on the ground, behind the car or is hanged over the car trunk so as to warn passing cars. However, most of conventional triangular warning signs are light-reflected that only shine by the reflection of sunshine or the light from passing vehicles. Once the light from sun or passing vehicles is not enough, reflecting and warning effect of the triangular sign is influenced. Furthermore, a traditional triangular warning sign has a cross mount that can be folded or opened. But the folded triangular sign not only has bad appearance but also has defect in supporting effect. Therefore, there is a need to improve the conventional triangular warning sign.

### SUMMARY OF THE INVENTION

Therefore it is a primary object of the present invention to provide a triangular warning sign with a triangular warning plane consisting of electro luminescent pieces or light-emitting diode so as to replace traditional reflection piece for providing enough brightness. Thus the device achieves better warning effect, longer life and higher safety.

It is another object of the present invention to provide a triangular warning sign that uses a power supply to provide the triangular warning plane comprising electro luminescent pieces or light-emitting diode electricity to make users more convenient. The power supply can be solar system, batteries, or a car charger.

It is another object of the present invention to provide a triangular warning sign that is disposed with an alarm which uses electricity from the power supply for buzzing so as to enhance warning effect.

It is another object of the present invention to provide a triangular warning sign that the power supply therein further having an automatically switch device so that the power source of the triangular warning plane can be switched between the solar system and the batteries depending on different situations for saving energy and protecting environment.

It is another object of the present invention to provide a triangular warning sign that further disposed with a hidden mount used in combination with the triangular carrier board and a stretchable supporting rod between rear side of the triangular carrier board and the opened mount for supporting the standing triangular carrier board.

### BRIEF DESCRIPTION OF THE DRAWINGS

FIG. 1 is a front view of an embodiment in accordance with the present invention;

FIG. 2 is a rear view of the embodiment in FIG. 1;

FIG. 3 is a partial cross sectional view of the embodiment in FIG. 2;

FIG. 4 is a front view of the embodiment in FIG. 1 while the mount is opened;

FIG. 5 is a rear view of the embodiment in FIG. 2 while the mount and the supporting rod are set up;

FIG. 6 is a rear view of the embodiment in FIG. 5 while the supporting rod is used;

FIG. 7 is a schematic drawing showing the present invention hanged on the car trunk in usage;

FIG. 8 is a schematic drawing showing the present invention set up on the ground behind the car.

### DETAILED DESCRIPTION OF THE PREFERRED EMBODIMENT

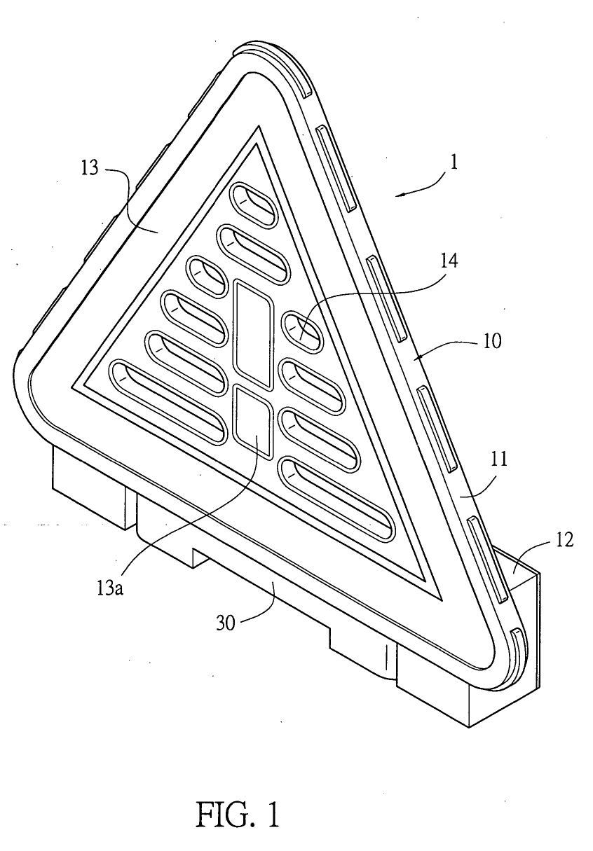

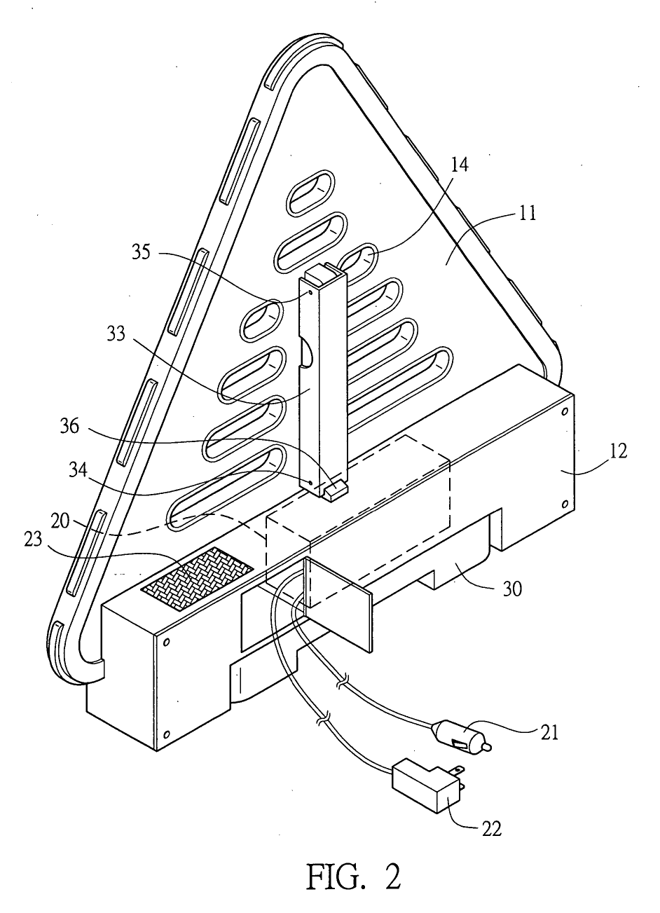

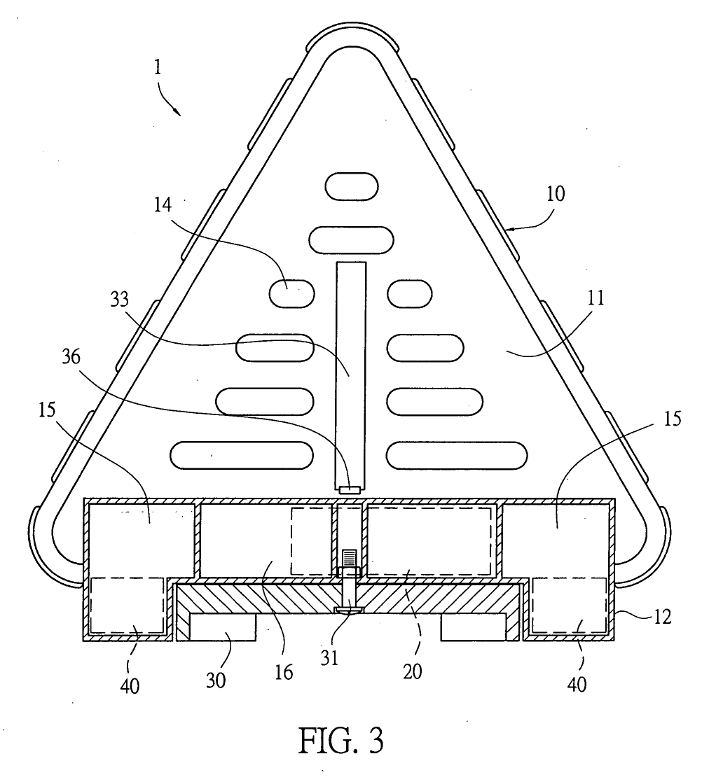

Refer to FIG. 1, FIG. 2 & FIG. 3, a triangular waning sign for vehicles 1 in accordance with the present invention includes a triangular carrier board 10, a power supply 20 and a mount 30. The triangular carrier board 10 is made by plastic injection molding and there is no limit on shape. As shown in figures, the triangular carrier board 10 having a triangular board 11 on upper end and a C-shaped bottom frame 12 on lower end. A triangular warning plane 13 is disposed on the triangular board 11 of the triangular carrier board 10. Or a triangular warning plane 13a with exclamation mark is arranged on center of the triangular warning plane 13. The triangular warning plane 13, 13a are composed by electro luminescent pieces, as shown in FIG. 1 or a plurality of light-emitting diode (not shown in figure). The electro luminescent pieces are made by fluorescent material arranged between two electrodes that illuminates when alternating current bias is applied to. During the process, there is no heat generated so that it is called electro luminescent (cold light). And the electro luminescent has features of light weight, particular thin thickness and varieties in colors. Moreover, either electro luminescent or LED is electricity-saving, safe, and with enough brightness. Furthermore, an Electro Luminescent (EL) triangular warning plane 13 can be made by printed the fluorescent material directly on the surface of the triangular board 11 or making a triangular fluorescent piece and then attached on the triangular board 11. Both can be mass-produced. A plurality of insertion holes 14 is mounted on the triangular board 11 so as to make the triangular board 11 less susceptible to wind pressure.

The C-shaped bottom frame 12 on lower part of the triangular carrier board 10 is on the bottom of the triangular board 11. Right and left slots 15 as well as central slot 16 are inside the C-shaped bottom frame 12. The right and left slots 15 is used to accommodate weight 40 such as iron block so as to enhance vertical supporting strength of the triangular carrier board 10 while the central slot 16 is for accommodating the power supply 20. There may be a housing with an opening covering the C-shaped bottom frame 12.

The power supply 20 can be a solar power supply, a battery power supply or a car charger with both AC (alternating current) and DC (direct current) charging capabilities. The whole power supply 20 including circuit boards of chargers, car charger plugs 21, general charger plugs 22 or battery holders can be mounted inside the central slot 16 of the C-shaped bottom frame 12. The solar panels 23 is set on surface of the C-shaped bottom frame 12, as shown in figures for converting solar energy into electricity. Furthermore, the poles of circuit of the power supply 20 are connected with the EL or LED triangular warning plane 13 for providing power so as to make the triangular warning plane 13 illuminate. The illumination pattern of the triangular warning plane 13 is controlled by a control circuit of the power supply 20. Moreover, there is an automatically switch device between the battery power supply (21 [symbol] 22) and the solar power supply (23). If the solar power supply (23) produce enough power to make the triangular warning plane 13 illuminate, the battery power supply (21 [symbol] 22) is turned off. Once the power from the solar power supply (23) is not enough, such as in the evening or at night, the device is automatically switched to the battery power supply (21 [symbol] 22). Thus the battery power is saved.

In addition, an alarm can be disposed inside the central slot 16 of the C-shaped bottom frame 12. When the triangular warning plane 13 illuminates for warning, the alarm using power from the power supply 20 is also buzzing so as to enhance the warning effect.

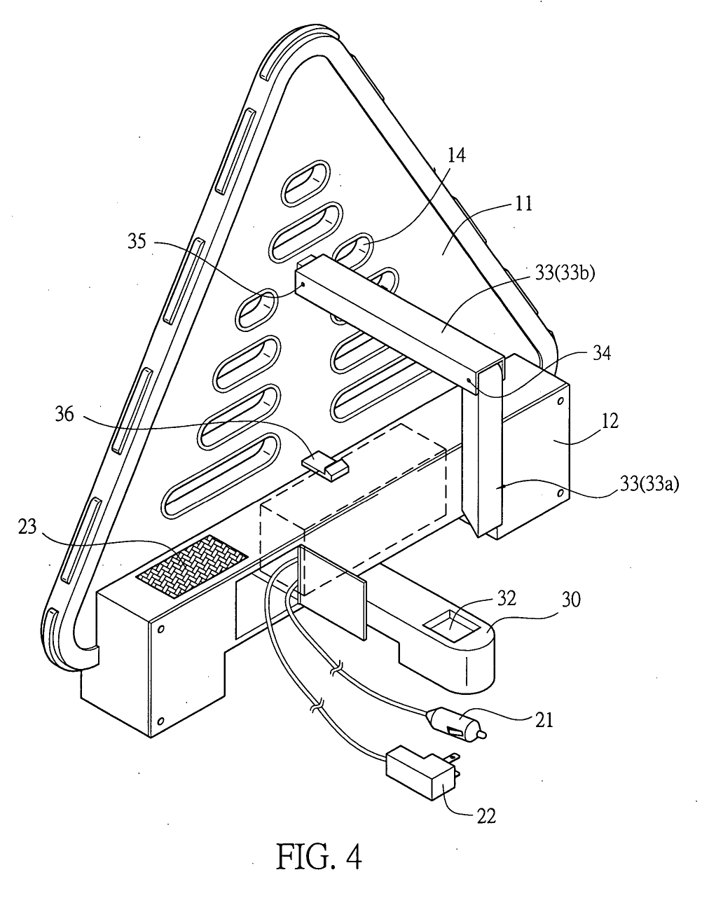

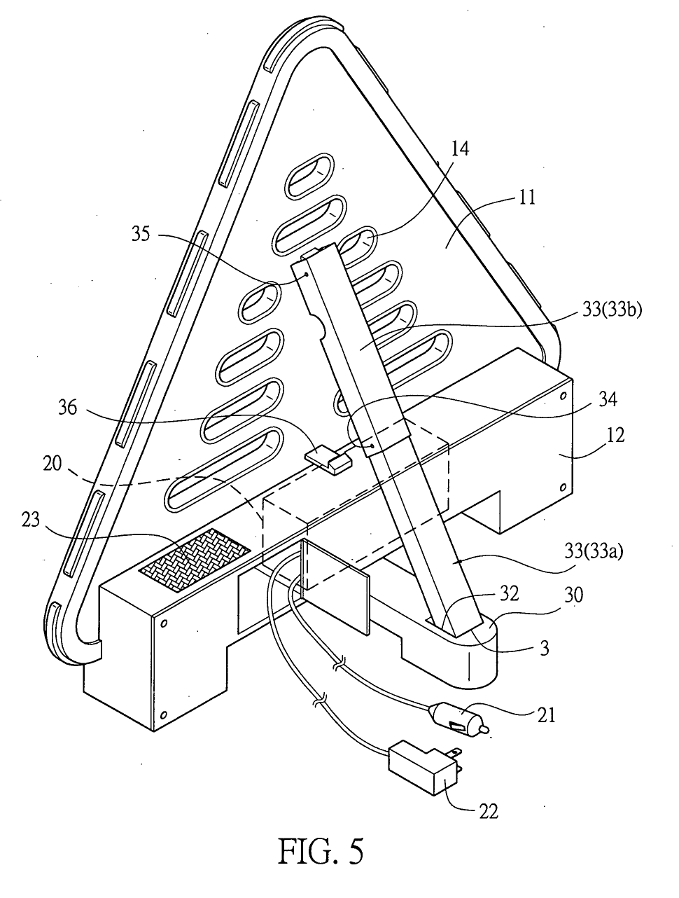

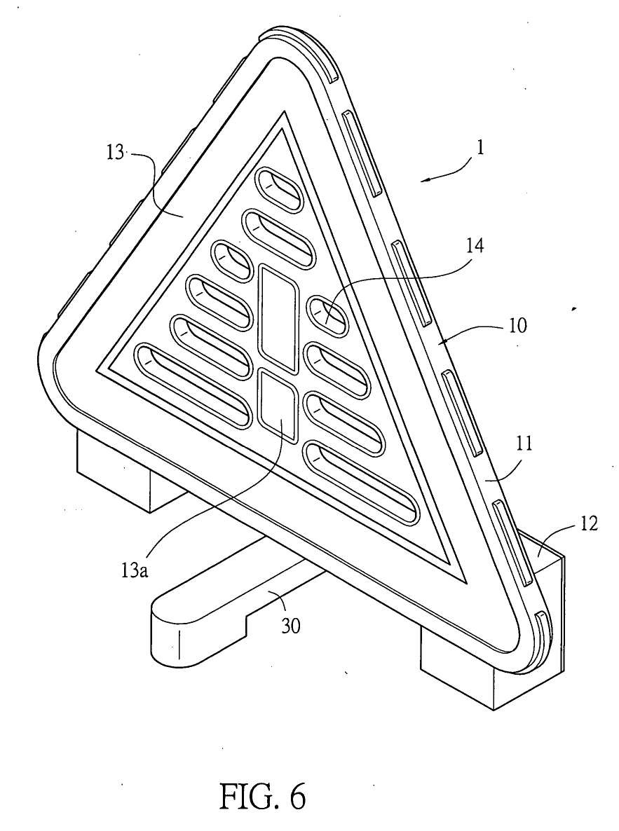

Refer to FIG. 4, FIG. 5 & FIG. 6, the mount 30 of the present invention is designed for being used in combination with the triangular carrier board 10. The mount 30 is a C-shaped frame made by plastic injection molding. By a pivoting shaft 31, the mount 30 is pivoted in the space inside the C-shaped bottom frame 12 while the right and left sides of the C-shaped mount 30 as well as the right and left sides of the C-shaped bottom frame 12 are in the same horizontal plane. The C-shaped mount 30 can be folded and hidden in the C-shaped space inside the C-shaped bottom frame 12 thus it has no influence on appearance of the triangular waning sign for vehicles 1. When the C-shaped mount 30 is opened, it is across the C-shaped bottom frame 12 for supporting the device standing firmly. A groove 32 is arranged on surface of a leg of the mount 30 for locking with the bottom of a supporting rod 33. The top of the supporting rod 33 is connected with the rear side of the triangular board 11 by a pivoting shaft 35. When the C-shaped mount 30 is opened, the supporting rod 33 is between rear side of the triangular board 11 and one supporting foot of the mount 30 so as to increase the supporting strength of the assembling of the triangular carrier board 10 and the mount 30. Moreover, the supporting rod 33 can be designed to be composed by an inner supporting rod 33a, a hollow outer supporting rod 33b and a pivoting shaft 34. The inner supporting rod 33a is connected and is inserted into the inner space of the hollow outer supporting rod 33b by the pivoting shaft 34. Thus the length of the supporting rod 33 is shortened and the supporting rod 33 is attached on rear side of the triangular board 11. Furthermore, a lock member 36 is arranged under the pivoting shaft 35 so as to fix the folded supporting rod 33.

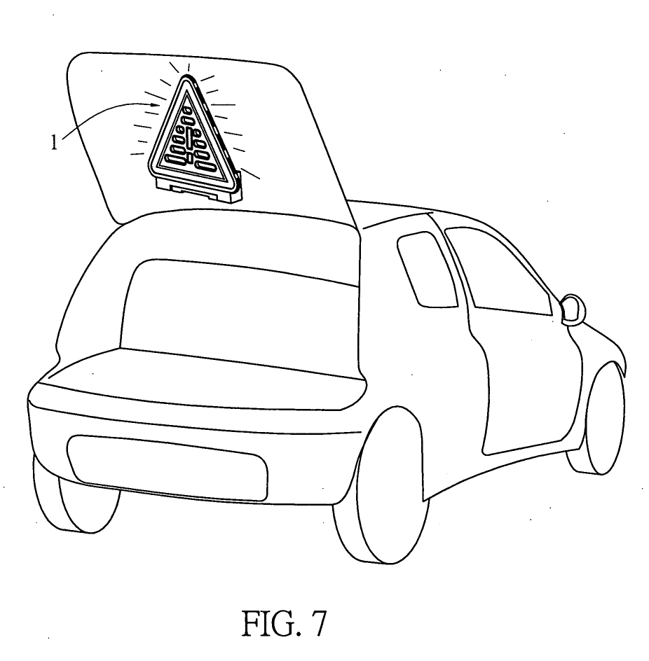

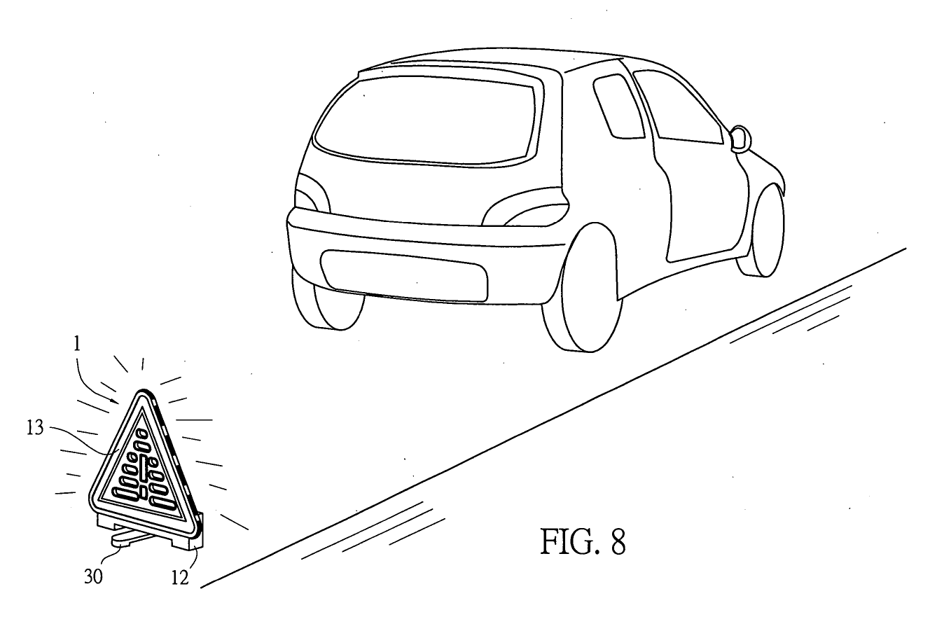

In usage, as shown in FIG. 7 & FIG. 8, the triangular warning plane 13 of the present invention illuminates by electro Luminescent or LED with features of electricity-saving, safety and enough brightness. Thus the present invention achieves good warning effect, convenience for users and energy saving.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A triangular warning sign for vehicles comprising a triangular carrier board, a power supply and a mount, wherein
the triangular carrier board is a plate or a frame with a triangular warning plane that is made by electroluminescent pieces on a front side thereof;
the power supply for providing electricity disposed on the triangular carrier board and two poles of a circuit thereof are connected to the electroluminescent pieces on the triangular warning plane so as to provide electricity to and control illumination of the triangular warning plane; and
the mount is disposed under the triangular carrier board for supporting the triangular warning plane of the triangular carrier board standing on and perpendicular to the ground while being opened,
wherein the power supply is a solar power supply, a battery power supply, or a car charger, and
wherein an automatically-switched device is arranged between the solar power supply and the battery power supply of the power supply alternating the source of power between the solar power supply and the battery power supply.

2. (canceled)

3. (canceled)

4. (canceled)

5. The device as claimed in claim 1, wherein the power supply further having an alarm.

6. The device as claimed in claim 1, wherein the triangular carrier board having a triangular board on upper side and a C-shaped bottom frame on lower end is made by plastic injection molding while the triangular warning plane is disposed on front side of the triangular board and the power supply is mounted inside the C-shaped bottom frame.

7. The device as claimed in claim 1, wherein the mount has a C-shaped configuration made by plastic injection molding and by a pivoting shaft, the mount is pivoted in inner space of a C-shaped opening on a bottom of the frame.

8. The device as claimed in claim 7, wherein an inclined supporting rod is disposed between the mount and a rear side of the triangular carrier board; one end of the supporting rod is locking with a groove on a surface of a leg of the mount while the other end thereof is pivoted with the rear side of the triangular board.

9. The device as claimed in claim 8, wherein the supporting rod having an inner supporting rod and an outer supporting rod, pivoting with each other; the inner supporting rod is foldable, pivoted and inserted into an inner space of the outer supporting rod so that the length of the supporting rod is shortened and the supporting rod is locked with a lock member on a rear side of the triangular board for being fixed.

10. (canceled)
